(19) United States
(12) Patent Application Publication
(10) Pub. No.: US 2008/0045641 A1
(43) Pub. Date: Feb. 21, 2008

(54) Water-dilutable or water soluble blocked polyisocyanates for producing aqueous 1K PU coating with rapid initial physical drying

(76) Inventors: Sebastian Dorr, Dusseldorf (DE); Beate Baumbach, Burscheid (DE); Wolfram Kuettner, Bergisch Gladbach (DE); Rolf Gertzmann, Leverkusen (DE)

Correspondence Address: BAYER MATERIAL SCIENCE LLC, 100 BAYER ROAD, PITTSBURGH, PA, 15205, US

(21) Appl. No.: 11/891,974

(22) Filed: Aug. 14, 2007

(30) Foreign Application Priority Data
Aug. 18, 2006 (DE) 102006038941.7

(51) Int. Cl. C08F 26/06

(52) U.S. Cl. 524/457; 524/592; 526/258

(57) ABSTRACT

The present invention relates to new water-dilutable or water-soluble blocked polyisocyanates which allow the preparation of bakeable one-component (1K) polyurethane coating materials which exhibit rapid initial physical drying, exhibit reduced thermal yellowing and lead to haze-free coatings, to a process for preparing them, and to their use.

### CROSS-REFERENCE TO RELATED APPLICATION

The present application claims the right of priority under 35 U.S.C. §119 (a)-(d) of German Patent Application Number 10 2006 038 941.7, filed Aug. 18, 2006.

### BACKGROUND OF THE INVENTION

The present invention relates to new water-dilutable or water-soluble blocked polyisocyanates which allow the preparation of bakeable one-component (1K) polyurethane coating materials which exhibit rapid initial physical drying, exhibit reduced thermal yellowing and lead to haze-free coatings, to a process for preparing them, and to their use.

In the coating of substrates there is an increasing use of aqueous binders, especially polyurethane (PU) dispersions with blocked isocyanate groups. The preparation of aqueous PU dispersions and the methods of coating and of baking are known.

Aqueous one-component polyurethane baking varnishes whose crosslinker component is composed substantially of blocked polyisocyanates (BNCO crosslinkers, crosslinker dispersions), however, exhibit slow initial physical drying following application of the coating. This leads to problems during transport of the coated articles to the baking oven in which the chemical crosslinking takes place. The articles, for example, may stick to conveyor belts or gloves. A long period of drying is therefore necessary prior to the baking operation.

Furthermore, one-component polyurethane baking varnishes with blocked isocyanate groups display a pronounced tendency towards yellowing at high baking temperatures or in long-lasting baking operations, or upon overbaking.

A further problem associated with the processing of one-component polyurethane baking varnishes with blocked isocyanate groups is the hazing of the coating film, which poses a particular hindrance to the coating of transparent substrates (such as glass) for the purpose of obtaining transparent coated systems.

EP-A 0802210 describes water-dilutable polyisocyanate crosslinkers with blocked isocyanate groups. To circumvent the problem of thermal yellowing, the use of compounds carrying hydrazide groups is proposed. The coating of glass in accordance with EP-A 0807650 using polyisocyanate crosslinkers of this kind does lead to clear, unyellowed films, but the initial physical drying behaviour of the systems is very slow and hence disadvantageous.

The mixed blocking of polyisocyanates with lactams and with other blocking agents is well known from the field of the non-aqueous polyurethane systems and is described in, for example, DE-A 10156897, DE-A 4416750, EP-A 0403044, DE-A 3128743 and U.S. Pat. No. 5,455,374. Conclusions of reduced yellowing or of advantageous initial drying behaviour, of aqueous PU systems in particular, through the use of lactam-based mixed blocking, however, are not possible.

It was an object of the present invention, then, to provide water-dilutable or water-soluble blocked polyisocyanates which in the form of an aqueous dispersion, after blending with polyol components, lead to bakeable one-component polyurethane coating materials with rapid initial physical drying after application and with low thermal yellowing on baking, or even on overbaking. A further object was to enable haze-free coating of substrates with the resultant coating composition.

It has now surprisingly been found that hydrophilicized polyisocyanates which exhibit mixed blocking with a lactam and a further blocking agent meet these requirements.

### SUMMARY OF THE INVENTION

The invention provides a process for preparing aqueous dispersions of mixedly blocked polyisocyanate prepolymers, comprising:

1) preparing a polyisocyanate prepolymer by reacting:
a) 100 equivalents of at least one polyisocyanate component,
b) 10 to 75 equivalents of one or more lactams, as blocking agent(s) for isocyanate groups,
c) 2 to 50 equivalents of further blocking agents for isocyanate groups, other than b),
d) 0 to 15 equivalents of at least one nonionic hydrophilicizing agent containing isocyanate-reactive groups,
e) 0.5 to 13 equivalents of at least one (potentially) anionic hydrophilicizing agent containing isocyanate-reactive groups,
f) 0 to 30 equivalents of one or more amino-free compounds of the molecular weight range from 62 to 250 g/mol which have either 2 to 4 OH groups or at least one OH group and at least one further isocyanate-reactive group, and
g) 0 to 30 equivalents of one or more (cyclo)aliphatic compounds of the molecular weight range from 32 to 300 g/mol which have either 2 to 4 amino groups or at least one amino group and at least one further isocyanate-reactive group,

2) dissolving or dispersing the polyisocyanate prepolymer in water during or after reaction of components a) to g) with one another, and

3) at least partially deprotanating the potentially anionic groups of the hydrophilicizing agents used in e) with a base before, during or after step 2).

### DETAILED DESCRIPTION OF THE PREFERRED EMBODIMENTS

The amounts of the components b) to g) in equivalents refer to the respective amounts of isocyanate-reactive groups of the compounds contained in these components, the isocyanate component used in a) having 100 equivalents of free NCO groups available for reaction.

In one preferred embodiment, the reactants a) to f) are reacted with one another and then dispersed or dissolved in water, this step being accompanied or followed by the at least partial deprotonation of the potentially anionic groups of the hydrophilicizing agents used in e) with a base. The optionally added component g) is preferably added after the prepolymer has been dispersed in water.

In one particularly preferred embodiment, component a) is reacted first of all with components d), e) and f), and this reaction is followed by reaction with component b) and then with component c). Subsequently a base is added for deprotonation and the reaction mixture is dispersed in water. Finally it is possible to add component g).

The proportions of the reactants are preferably selected such that the equivalent ratio of the isocyanate component a) to isocyanate-reactive groups of components b), c), d), f) and g) is 1:0.7 to 1:1.3, preferably 1:0.85 to 1:1.1. The calculation of this equivalent ratio is made with exclusion not only of the acid groups of component e) but also of the solvent or water used to prepare solutions or dispersions of the polyurethanes, and also of the deprotonating agent used to deprotonate the acid groups.

Suitable polyisocyanates used in component a) are the NCO-functional compounds that are known per se to a person skilled in the art and have a functionality of preferably 2 or more. These are typically aliphatic, cycloaliphatic, araliphatic and/or aromatic di- or triisocyanates and also their higher molecular weight derivatives having iminooxadiazinedione, isocyanurate, uretdione, urethane, allophanate, biuret, urea, oxadiazinetrione, oxazolidinone, acylurea and/or carbodiimide structures, and containing two or more free NCO groups.

Examples of such di- or triisocyanates are tetramethylene diisocyanate, cyclohexane 1,3- and 1,4-diisocyanate, hexamethylene diisocyanate (HDI), 1-isocyanato-3,3,5-trimethyl-5-isocyanatomethylcyclohexane(isophorone diisocyanate, IPDI), methylenebis(4-isocyanatocyclohexane), tetramethylxylenene diisocyanate (TMXDI), triisocyanatononane, tolylene diisocyanate (TDI), diphenylmethane 2,4′- and/or 4,4′-diisocyanate (MDI), triphenylmethane 4,4′-diisocyanate, naphthylene 1,5-diisocyanate, 4-isocyanatomethyloctane 1,8-diisocyanate(nonane triisocyanate, triisocyanatononane, TIN) and/or 1,6,11-undecane triisocyanate and also any desired mixtures thereof and, optionally, mixtures of other di-, tri- and/or polyisocyanates too.

Such polyisocyanates typically have isocyanate contents of 0.5% to 60%, preferably 3% to 30%, more preferably 5% to 25% by weight.

In the process of the invention it is preferred to use the relatively high molecular weight compounds having isocyanurate, urethane, allophanate, biuret, iminooxadiazinetrione, oxadiazinetrione and/or uretdione groups that are based on aliphatic and/or cycloaliphatic diisocyanates.

In the process of the invention it is particularly preferred to use, in component a), compounds having biuret, iminooxadiazinedione, isocyanurate and/or uretdione groups that are based on hexamethylene diisocyanate, isophorone diisocyanate and/or 4,4′-diisocyanatocyclohexylmethane.

Very particular preference is given to using polyisocyanates with an isocyanurate structure that are based on isophorone diisocyanate.

Blocking agents suitable as component b) are lactams (cyclic amides) which possess an amidic H atom. Examples are λ-butyrolactam(2-pyrrolidone), δ-valerolactam and/or ε-caprolactam; ε-caprolactam is preferred. Component b) is used in an amount of preferably 30 to 65 equivalents, based on the NCO groups of the isocyanate component a).

As component c) it is possible to use the monofunctional blocking agents which are known per se in the art for the blocking of isocyanate groups and which are not contained in component b). Examples are phenols, oximes, such as butanone oxime, acetone oxime or cyclohexanone oxime, amines such as N-tert-butylbenzylamine or diisopropylamine, 3,5-dimethylpyrazole, triazole, esters containing deprotonatable groups, such as diethyl malonate, ethyl acetoacetate, and mixtures thereof and/or mixtures with other blocking agents. Preference is given to butanone oxime, acetone oxime, 3,5-dimethylpyrazole and/or mixtures thereof, particular preference to butanone oxime. Component c) is used in an amount of preferably 10 to 30 equivalents, based on the NCO groups of isocyanate component a).

The hydrophilicizing component d) is composed of at least one nonionically hydrophilicizing compound which contains isocyanate-reactive groups. Examples of these compounds include polyoxyalkylene ethers which contain at least one hydroxyl or amino group and also one or more oxyalkylene units, of which at least one is an oxyethylene unit. These polyoxyalkylene ethers are obtainable in conventional manner by alkoxylation of suitable starter molecules.

Examples of suitable starter molecules are saturated monoalcohols such as methanol, ethanol, n-propanol, isopropanol, n-butanol, isobutanol, sec-butanol, the isomeric pentanols, hexanols, octanols and nonanols, n-decanol, n-dodecanol, n-tetradecanol, n-hexadecanol, n-octadecanol, cyclohexanol, the isomeric methylcyclohexanols or hydroxymethylcyclohexane, 3-ethyl-3-hydroxymethyl-oxetane or tetrahydrofurfuryl alcohol, diethylene glycol monoalkyl ethers, such as diethylene glycol monobutyl ether, unsaturated alcohols such as allyl alcohol, 1,1-dimethylallyl alcohol or oleyl alcohol, aromatic alcohols such as phenol, the isomeric cresols or methoxyphenols, araliphatic alcohols such as benzyl alcohol, anisyl alcohol or cinnamyl alcohol, secondary monoamines such as dimethyl-amine, diethylamine, dipropylamine, diisopropylamine, dibutylamine, bis(2-ethylhexyl)amine, N-methyl- and N-ethylcyclohexylamine or dicyclohexylamine, and heterocyclic secondary amines such as morpholine, pyrrolidine, piperidine or 1H-pyrazole. Preferred starter molecules are saturated monoalcohols. Particular preference is given to using diethylene glycol monobutyl ether as a starter molecule.

Alkylene oxides suitable for the alkoxylation reaction are, in particular, ethylene oxide and propylene oxide, which can be used in any order or else in a mixture for the alkoxylation reaction. Preference is given to the blockwise addition of ethylene oxide and propylene oxide with the starter.

The polyalkylene oxide polyethers are either pure polyethylene oxide polyethers or mixed polyalkylene oxide polyethers of whose alkylene oxide units preferably at least 30 mol % and more preferably at least 40 mol % are composed of ethylene oxide units. Preferred nonionic compounds are monofunctional mixed polyalkylene oxide polyethers which have at least 40 mol % of ethylene oxide units and not more than 60 mol % of propylene oxide units.

The amount of ethylene oxide units in relation to the total solids content of components a) to g) is below 30%, preferably below 20%, more preferably below 15% by weight.

Component d) is used in an amount of preferably 3 to 8 equivalents, based on the NCO groups of the isocyanate component a).

The hydrophilicizing component e) is composed of at least one (potentially) anionic compound having at least one group that is reactive towards isocyanate groups.

These compounds are preferably carboxylic acids having at least one, preferably one or two, hydroxyl groups, or salts of such hydroxycarboxylic acids. Examples of suitable such acids include 2,2-bis(hydroxymethyl)alkanecarboxylic acids such as dimethylolacetic acid, 2,2-dimethylolpropionic acid, 2,2-dimethylolbutyric acid or 2,2-dimethylolpentanoic acid, dihydroxysuccinic acid, hydroxypivalic acid or mixtures of such acids.

As component e) it is preferred to use dimethylolpropionic acid and/or hydroxypivalic acid.

The free acid groups, particularly carboxyl groups, represent the aforementioned “potentially anionic” groups, whereas the saltlike groups that are obtained by neutralization with bases, more particularly carboxylate groups, are the “anionic” groups referred to above.

Component e) is used in an amount of preferably 5 to 9 equivalents, based on the NCO groups of the isocyanate component a). Groups defined as isocyanate-reactive groups in this case are the alcohol groups; the carboxylic acid groups and/or carboxylate groups are not rated as isocyanate-reactive groups.

Examples of suitable chain extender components f) include diols, triols and/or polyols. Examples are ethanediol, di-, tri- and tetraethylene glycol, 1,2-propanediol, di-, tri- and tetrapropylene glycol, 1,3-propanediol, butane-1,4-diol, butane-1,3-diol, butane-2,3-diol, pentane-1,5-diol, hexane-1,6-diol, 2,2-dimethyl-1,3-propanediol, 1,4-dihydroxycyclohexane, 1,4-dimethylolcyclohexane, octane-1,8-diol, decane-1,10-diol, dodecane-1,12-diol, trimethylolpropane, castor oil, glycerol and/or mixtures of the stated products, optionally with further diols, triols and/or polyols. Ethoxylated and/or propoxylated diols, triols and/or polyols as well, such as ethoxylated and/or propoxylated trimethylolpropane, glycerol and/or hexane-1,6-diol, for example, can be used.

Additionally, the use of compounds which as well as at least one hydroxyl group also contain one or more thiol groups such as 1,2-hydroxyethanethiol, is possible.

As component f) it is preferred to use butane-1,4-diol, butane-1,3-diol, 2,2-dimethyl-1,3-propanediol, hexane-1,6-diol and/or trimethylpropane.

Preference is given to using in f) compounds of the aforementioned kind having molecular weights of 62 to 200 g/mol.

Component f) is used in an amount of preferably 3 to 15 equivalents, based on the NCO groups of the isocyanate component a).

As chain extender component g) it is possible to use isocyanate-reactive organic diamines or polyamines such as 1,2-ethylenediamine, 1,2- and 1,3-diaminopropane, 1,4-diaminobutane, 1,6-diaminohexane, isophoronediamine, an isomer mixture of 2,2,4- and 2,4,4-trimethylhexamethylenediamine, 2-methylpentamethylenediamine, diethylenetriamine, 4,4-diamino-dicyclohexylmethane, and/or dimethylethylenediamine

As component g) it is also possible, moreover, to use compounds which as well as a primary amino group also have secondary amino groups, or which as well as an amino group (primary or secondary) also have OH groups or SH groups.

Examples of such compounds are primary/secondary amines, such as 3-amino-1-methylaminopropane, 3-amino-1-ethylaminopropane, 3-amino-1-cyclohexyl-aminopropane, 3-amino-1-methylaminobutane, alkanolamines such as N-aminoethylethanolamine, ethanolamine, diethanolamine, 3-aminopropanol, 1-aminopropanol, neopentanolamine, N-methylethanolamine and/or N-methyl-isopropanolamine and alkanethiol amines, such as 1-aminopropanethiol.

As component g) it is preferred to use diamines or polyamines, such as ethylenediamine, isophoronediamine, 1,6-diaminohexane and/or 4,4-diaminodicyclohexylmethane.

In component g) it is preferred to use compounds of the aforementioned kind having molecular weights of 60 to 300 g/mol.

Component g) is used in an amount of preferably 0 to 10 equivalents, based on the NCO groups of the isocyanate component a).

For chain extension it is also possible to use mixtures of components f) and g).

Besides chain extension by reaction with components f) and/or g) it is also possible for free NCO groups to react with water, in the course of dispersion, for example, with formation of amine, the primary amino groups thus formed being consumed by reaction in turn with free NCO groups, with accompanying chain extension.

In the preparation of the dispersion of the invention it is also possible to use solvents and/or for the raw materials to be used as solutions. Examples of suitable solvents are N-methylpyrrolidone, N-ethylpyrrolidone, xylene, toluene, butyl acetate, methoxypropyl acetate, acetone or methyl ethyl ketone.

Where volatile, (partly) water-miscible solvents such as acetone or methyl ethyl ketone are used they are typically separated off by distillation following dispersion in water. This procedure is also termed the acetone process or slurry process. The advantage lies in a reduced viscosity for the preparation of the prepolymer, without the solvent still being present in the completed dispersion.

A further possibility is to add solvent after the consumption of the isocyanate groups by reaction. In this case it is also possible to employ protic solvents such as alcohols, which serve for example to stabilize the dispersion or to improve coating-material properties.

The amount of the water that is used as the dispersing medium is generally made such that the resulting dispersions are 20% to 60% by weight dispersions, preferably 30% to 45% by weight dispersions, based on solids content in water.

Examples of deprotonating agents for converting the potentially anionic groups into their anionic form are basic compounds such as sodium hydroxide, potassium hydroxide, ammonia, primary or secondary amines, such as diisopropanolamine or 2-amino-2-methyl-1-propanol, tertiary amines such as triethylamine, dimethyl-cyclohexylamine, diisopropylcyclohexylamine, diisopropylethylamine, triethanolamine, methyldiethanolamine, N,N-dimethylaminoethanol, or N-methylmorpholine, or any desired mixtures thereof.

Preferred deprotonating agents are tertiary amines such as triethylamine, diisopropylethylamine and N,N-dimethylethanolamine; N,N-dimethylethanolamine is particularly preferred.

The amount of deprotonating agent used is generally made such that the degree of deprotonation of the carboxylic acid groups present in the polyurethanes of the invention (molar ratio of amine/hydroxide employed to acid groups present) is at least 40%, preferably 70% to 130%, more preferably 90% to 110%. This deprotonation may take place before, during or after the dispersing or dissolving step. Preference is nevertheless given to deprotonation prior to the addition of water.

To accelerate the urethanization during prepolymer preparation, a further possibility is to add catalysts to the reaction mixture. Examples of suitable catalysts include tertiary amines, tin compounds, zinc compounds or bismuth compounds, or basic salts. Those preferred are dibutyltin dilaurate and dibutyltin dioctoate.

The invention further provides the aqueous dispersions of mixedly blocked polyisocyanate prepolymers that are obtained by the above-described process, and also the prepolymers contained therein themselves.

The invention likewise provides the mixedly blocked polyisocyanate prepolymers characterized in that they comprise

A) at least one structural unit of the formula (I)

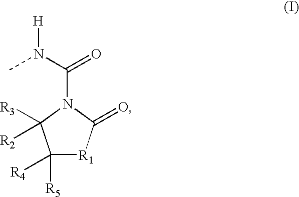

where

R₁ is a C₁ to C₃ alkylene radical and

R₂ to R₅ is a hydrogen atom,

B) (potentially) anionically hydrophilicizing groups and

C) optionally one or more oxyethylene units.

The dispersions of the invention and also the mixedly blocked prepolymers of the invention can be used for producing aqueous, bakeable coating compositions (baking varnishes), for the coating of substrates, preferably of metals, minerals, wood, plastics, for industrial coating for example, glass, in textile coating and in automotive OEM finishing.

Additionally provided by the invention are the use of the dispersions of mixedly blocked polyisocyanate prepolymers of the invention in the preparation of coating compositions, and also the resultant coating compositions and coatings themselves, and the substrates provided with such coatings.

For the preparation of coating compositions of this kind, the dispersions of the invention are typically blended with water-soluble or -dispersible polyhydroxy compounds and optionally auxiliaries and adjuvants.

Suitable polyhydroxyl compounds for this end use and also further details relating to the preparation and application of such baking varnishes are known. They are preferably the conventional aqueous or water-thinnable binders based on polyhydroxy polyesters, polyhydroxy polyurethanes, polyhydroxy polyethers, polycarbonate diols or hydroxyl-containing polymers, such as the conventional polyhydroxy polyacrylates, polyacrylate polyurethanes and/or polyurethane polyacrylates.

They are typically hydrophilically modified, as described for example in EP-A-0 157 291, EP-A-0 498 156 or EP-A-0 427 028.

Such polyhydroxyl compounds generally have a hydroxyl number of 20 to 200, preferably of 50 to 130 mg KOH/g.

In the coating compositions of the invention it is possible, in addition to the inventively essential dispersions, to use other alcohol-reactive compounds as well, such as amino crosslinker resins such as melamine resins and/or urea resins for additional crosslinking on baking. Likewise possible is the use of further hydrophilic polyisocyanates.

Auxiliaries and adjuvants that can be added are the substances that are typical per se, such as pigments, fillers, flow control agents, defoamers and catalysts. To improve coating-material adhesion it is possible for the coating materials to include commercially customary additives such as, for example, mercaptosilanes such as 3-mercaptopropyltrimethoxysilane, epoxyalkylsilanes such as 3-glycidyloxypropyltriethoxysilane, aminoalkylsilanes such as 3-aminopropyltriethoxysilane, their hydrolysis products, or mixtures of these components.

The coating compositions of the invention are prepared by methods which are known per se.

For the purpose of coating it is possible for the coating compositions of the invention to be applied by knife coating, dipping, by spray application such as compressed-air spraying or airless spraying, and also by electrostatic application, as for example high-speed rotating bell application. The dry film thickness may for example be 10 to 120 μm. The dried films are cured by baking in the temperature range from 90 to 200° C., preferably 130 to 190° C., more preferably 140 to 180° C. Curing under the influence of microwave radiation is also possible. Baking may be preceded by physical drying of the film, for example at temperatures between 20 and 90° C.

### EXAMPLES

Unless noted otherwise, all percentages are by weight.

Unless noted otherwise, all analytical measurements relate to temperatures of 23° C.

The reported viscosities were determined by means of rotational viscometry in accordance with DIN 53019 at 23° C. using a rotational viscometer from Anton Paar Germany GmbH, Ostfildern, DE.

NCO contents, unless expressly mentioned otherwise, were determined volumetrically in accordance with DIN-EN ISO-11 909.

The particle sizes reported were determined by means of laser correlation spectroscopy (instrument: Malvern Zetasizer 1000, Malvern Instr. Limited).

The solids contents were determined by heating of a weighed sample at 120° C. When constant weight was reached, the sample was weighed again to allow calculation of the solids content.

Monitoring for free NCO groups was carried out by means of IR spectroscopy (band at 2260 cm⁻¹).

The adhesion was determined by means of DIN EN ISO 2409 crosshatch.

The König pendulum hardness was determined in accordance with DIN 53157.

Thermal yellowing was determined by the CIELAB method corresponding to DIN 6174.

Chemicals:

Desmodur® Z 4470 M/X:

Aliphatic polyisocyanate based on isophorone diisocyanate as a 70% strength solution in a mixture of methoxypropyl acetate and xylene (1/1), isocyanate content approximately 12%, Bayer MaterialScience AG, Leverkusen, DE.

Carbowax® 750:

Methoxypolyethylene glycol with an average molar mass of 750 g/mol from The Dow Chemical Company, Stade, Del.

Bayhydrol® A 145:

Water-dilutable, OH-functional polyacrylate dispersion, approximately 45% in water/solvent naphtha 100/2-butoxyethanol, neutralized with dimethylethanolamine, proportion approximately 45.6:4:4:1.4; OH content approximately 7.3%, Bayer MaterialScience AG, Leverkusen, DE

Bayhydrol® VP LS 2239:

Water-dilutable, hydroxyl-containing polyurethane dispersion, approximately 35% in water/NMP (60:5), OH content approximately 1.6%, Bayer MaterialScience AG, Leverkusen, DE

Bayhydur® VP LS 2240:

Hydrophilicized, blocked polyisocyanate crosslinker based on Desmodur® W, approximately 35% in water/MPA/xylene (56:4.5:4.5), NCO content (blocked) approximately 2.5%, Bayer MaterialScience AG, Leverkusen, DE

The other chemicals were purchased from the fine chemicals business of Sigma-Aldrich GmbH, Taufkirchen, DE.

### Example 1

Not inventive, preparation of a crosslinker dispersion blocked with butanone oxime

At 70° C. in a standard stirred apparatus with nitrogen blanketing, 359.0 g of Desmodur® Z 4470 M/X were admixed in succession with a solution of 4.7 g of dimethylolpropionic acid in 9.4 g of N-methylpyrrolidone (NMP), 37.5 g of Carboxwax® 750 and 3.39 g of neopentyl glycol. The batch was then heated to 80° C. and stirred until a constant NCO value of 8.02% (calculated: 8.27%) was reached. It was cooled to 70° C. Then 71.0 g of butanone oxime were added at a rate such that the temperature in the reaction vessel did not exceed 80° C. This was followed by further stirring at 80° C. until NCO groups were no longer detectable by IR spectroscopy, then by cooling to 70° C. and addition of 2.50 g of dimethylethanolamine. After further cooling to 60° C., the batch was dispersed with 570.8 g of deionized water at 25° C. It was conditioned at 50° C., stirred for 1 hour and left to cool to room temperature with stirring.

The properties of the resulting dispersion were as follows:

| | |
|---|---|
| Solids content | 35.8% |
| pH | 8.02 |
| Viscosity (Haake rotational viscometer, 23° C.) | 60 mPas |
| Particle size (laser correlation spectroscopy, LCS) | 99 nm |

### Example 2

Not inventive, preparation of a crosslinker dispersion blocked with acetone oxime

At 70° C. in a standard stirred apparatus with nitrogen blanketing, 466.66 g of Desmodur® Z 4470 M/X were admixed with a solution of 13.1 g of dimethylolpropionic acid in 26.2 g of N-methylpyrrolidone (NMP). The batch was then heated to 80° C. and stirred until a constant NCO value of 9.12% (calculated: 9.17%) was reached. Then 48.75 g of Carbowax® 750 were added and the mixture was stirred at 75° C. until an NCO value of 7.84 (calculated: 7.87%) was reached. It was then cooled to 70° C. and thereafter 76.0 g of acetone oxime were added at a rate such that the temperature in the reaction vessel did not exceed 80° C. This was followed by further stirring at 80° C. until NCO groups were no longer detectable by IR spectroscopy, then by cooling to 70° C. and addition of 8.70 g of dimethylethanolamine. After further cooling to 60° C., the batch was dispersed with 1548 g of deionized water at 25° C. It was conditioned at 50° C., stirred for 1 hour and left to cool to room temperature with stirring.

The properties of the resulting dispersion were as follows:

| | |
|---|---|
| Solids content | 31.4% |
| pH | 8.14 |
| Viscosity (Haake rotational viscometer, 23° C.) | 900 mPas |
| Particle size (laser correlation spectroscopy, LCS) | 45 nm |

### Example 3

Not inventive, preparation of a crosslinker dispersion blocked with caprolactam

At 70° C. in a standard stirred apparatus with nitrogen blanketing, 359.0 g of Desmodur® Z 4470 M/X were admixed in succession with a solution of 4.7 g of dimethylolpropionic acid in 9.4 g of N-methylpyrrolidone (NMP), 37.5 g of Carboxwax® 750 and 3.39 g of neopentyl glycol. The batch was then heated to 80° C. and stirred until a constant NCO value of 8.02% (calculated: 8.27%) was reached. It was cooled to 70° C. and then 92.3 g of ε-caprolactam were added. This was followed by further stirring at 100° C. until NCO groups were no longer detectable by IR spectroscopy, then by cooling to 70° C. and addition of 2.50 g of dimethylethanolamine. After further cooling to 60° C., the batch was dispersed with 770.53 g of deionized water at 25° C. It was conditioned at 50° C., stirred for 1 hour and left to cool to room temperature with stirring.

The properties of the resulting dispersion were as follows:

| | |
|---|---|
| Solids content | 36.5% |
| pH | 7.75 |
| Viscosity (Haake rotational viscometer, 23° C.) | 85 mPas |
| Particle size (laser correlation spectroscopy, LCS) | 82 nm |

### Example 4

Inventive, preparation of a crosslinker dispersion blocked mixedly

At 70° C. in a standard stirred apparatus with nitrogen blanketing, 359.0 g of Desmodur® Z 4470 M/X were admixed in succession with a solution of 4.7 g of dimethylolpropionic acid in 9.4 g of N-methylpyrrolidone (NMP), 37.5 g of Carbowax® 750 and 3.39 g of neopentyl glycol. The batch was then heated to 80° C. and stirred until a constant NCO value of 8.24% (calculated: 8.27%) was reached. It was cooled to 70° C. and then 63.4 g of ε-caprolactam were added. Stirring was continued at 100° C. until a constant NCO value of 1.75% (calculated: 1.76%) was reached, followed by cooling to 75° C. and addition of 17.4 g of butanone oxime. Stirring was continued until NCO groups were no longer detectable by IR spectroscopy, then by cooling to 70° C. and addition of 2.50 g of dimethylethanolamine. After further cooling to 60° C., the batch was dispersed with 582 g of deionized water at 25° C. It was conditioned at 50° C., stirred for 1 hour and left to cool to room temperature with stirring.

The properties of the resulting dispersion were as follows:

| | |
|---|---|
| Solids content | 35.9% |
| pH | 8.55 |
| Viscosity (Haake rotational viscometer, 23° C.) | 138 mPas |
| Particle size (laser correlation spectroscopy, LCS) | 87 nm |

### Example 5

Inventive, preparation of a crosslinker dispersion blocked mixedly

The procedure described in Example 4 was repeated but using 74.7 g of ε-caprolactam and 8.7 g of butanone oxime as blocking agents.

The properties of the resulting dispersion were as follows:

| | |
|---|---|
| Solids content | 36.9% |
| pH | 8.07 |
| Viscosity (Haake rotational viscometer, 23° C.) | 120 mPas |
| Particle size (laser correlation spectroscopy, LCS) | 88 nm |

### Example 6

Inventive, preparation of a crosslinker dispersion blocked mixedly

The procedure described in Example 4 was repeated but using 52.1 g of ε-caprolactam and 26.1 g of butanone oxime as blocking agents.

The properties of the resulting dispersion were as follows:

| | |
|---|---|
| Solids content | 36.3% |
| pH | 8.62 |
| Viscosity (Haake rotational viscometer, 23° C.) | 113 mPas |
| Particle size (laser correlation spectroscopy, LCS) | 86 nm |

### Example 7

Inventive, preparation of a crosslinker dispersion blocked mixedly

The procedure described in Example 4 was repeated but using 19.2 g of 3,5-dimethylpyrazole instead of butanone oxime as blocking agent.

The properties of the resulting dispersion were as follows:

| | |
|---|---|
| Solids content | 36.2% |
| pH | 8.4 |
| Viscosity (Haake rotational viscometer, 23° C.) | 160 mPas |
| Particle size (laser correlation spectroscopy, LCS) | 97 nm |

### Example 8

Inventive, preparation of a crosslinker dispersion blocked mixedly

The procedure described in Example 4 was repeated but using 55.4 g of δ-valerolactam (instead of ε-caprolactam) and 17.4 g of butanone oxime as blocking agents.

The properties of the resulting dispersion were as follows:

| | |
|---|---|
| Solids content | 36.8% |
| pH | 7.8 |
| Viscosity (Haake rotational viscometer, 23° C.) | 100 mPas |
| Particle size (laser correlation spectroscopy, LCS) | 93 nm |

For determination of the performance data, the blended coating materials of Examples 9 to 18 were formulated in accordance with Table 1, applied and cured. The performance data are contained in Table 2.

Table 1

Clearcoat materials 9 to 18 were prepared by mixing the blocked polyisocyanates with the polyol component in the ratio of their equivalent weights (BNCO:OH 1:1). To improve their adhesion, the coating materials include commercially customary additives (1.1%, calculated on the basis of solid binder).

TABLE 1

| Ingredients | Example 09 | Example 10 | Example 11 | Example 12 | Example 13 |
|---|---|---|---|---|---|
| Crosslinker | 61.00 g | | | | |
| Bayhydur ® | | | | | |
| VP LS 2240 | | | | | |
| Crosslinker of | | 53.89 | | | |
| Example 1 | | | | | |
| Crosslinker of | | | 57.10 | | |
| Example 2 | | | | | |
| Crosslinker of | | | | 55.04 | |
| Example 3 | | | | | |
| Crosslinker | | | | | 56.50 |
| mixture of | | | | | |
| Example 1 | | | | | |
| with 3 | | | | | |
| (26.3:73.7) | | | | | |
| Bayhydrol ® | 37.00 | 44.11 | 40.9 | 42.96 | 41.40 |
| VP LS 2239 | | | | | |
| Silquest ® A | 2.00 g | 2.00 | 2.00 | 2.00 | 2.00 |
| 189 | | | | | |
| (Crumbton | | | | | |
| GmbH)/ | | | | | |
| Dynasilan | | | | | |
| AMEO | | | | | |
| (ABCR | | | | | |
| Chemie | | | | | |
| GmbH), 20% | | | | | |
| in dipropylene | | | | | |
| glycol | | | | | |
| Ingredients | Example 14 | Example 15 | Example 16 | Example 17 | Example 18 |
| Crosslinker of | 56.51 | | | | |
| Example 4 | | | | | |
| Crosslinker of | | 57.70 | | | |
| Example 4 + | | | | | |
| Bayhydur ® | | | | | |
| 2240 (1:1 | | | | | |
| blend) | | | | | |
| Crosslinker of | | | 46.00 | | |
| Example 4 | | | | | |
| Crosslinker of | | | | 56.32 | |
| Example 7 | | | | | |
| Crosslinker of | | | | | 55.52 |
| Example 8 | | | | | |
| Bayhydrol ® | 41.49 | 40.3 | 52.00 | 41.68 | 42.48 |
| VP LS 2239 | | | | | |
| Bayhydrol ® | | | | | |
| A 145 | | | | | |
| Silquest ® A | 2.00 | 2.00 | 2.00 | 2.00 | 2.00 |
| 189 | | | | | |
| (Crumbton | | | | | |
| GmbH)/ | | | | | |
| Dynasilan | | | | | |
| AMEO | | | | | |
| (ABCR | | | | | |
| Chemie | | | | | |
| GmbH), 20% | | | | | |
| in dipropylene | | | | | |
| glycol | | | | | |

The above clearcoat materials were applied to glass plates 3 mm thick, from Schlier & Hennes, using a coating knife from Deka (No. 120) and were baked in a forced-air oven at 170° C. for 30 minutes. This gave dry film thicknesses of approximately 25-30 μm.

Table 2:

The following technical properties were found:

TABLE 2

| Technical | | | | | |
|---|---|---|---|---|---|
| properties of | | | | | |
| coating materials | Example 09 | Example 10 | Example 11 | Example 12 | Example 13 |
| Adhesion* | 0 | 0 | 0 | 0 | 0 |
| König pendulum | 158 | 190 | 196 | 191 | 192 |
| hardness (s) | | | | | |
| ^{a)}Solvent resistance* | 0001 | 0001 | 0001 | 0002 | 0002 |
| exposure time: 5 min | | | | | |
| (xylene, MPA, ethyl | | | | | |
| acetate/acetone) | | | | | |
| ^{b)}NaOH resistance* | 0 | 0 | 0 | 0 | 0 |
| (5% strength NaOH | | | | | |
| at 70° C., 8 h | | | | | |
| exposure) | | | | | |
| Yellowing (Δb value) | 1.60 | 0.74 | 1.10 | 1.10 | 0.90 |
| ^{c)}Initial physical | 5 | 3 | 3-4 | 0-1 | 1 |
| drying* (3 min at | | | | | |
| 80° C.) | | | | | |
| ^{d)}Film hazing | 0 | 0 | 0 | 4 | 4 |
| (visual) | | | | | |
| Technical | | | | | |
| properties of | | | | | |
| coating materials | Example 14 | Example 15 | Example 16 | Example 17 | Example 18 |
| Adhesion* | 0 | 0 | 0 | 0 | 0 |
| König pendulum | 195 | 182 | 204 | 206 | 216 |
| hardness (s) | | | | | |
| ^{a)}Solvent resistance* | 0002 | 0002 | 0002 | 0002 | 0002 |
| exposure time: 5 min | | | | | |
| (xylene, MPA, ethyl | | | | | |
| acetate/acetone) | | | | | |
| ^{b)}NaOH resistance* | 0 | 0 | 0 | 0 | 0 |
| (5% strength NaOH | | | | | |
| at 70° C., 8 h | | | | | |
| exposure) | | | | | |
| Yellowing (Δb value) | 0.62 | 0.87 | 0.65 | 0.69 | 1.70 |
| ^{c)}Initial physical | 0-1 | 1-2 | 1 | 1 | 1 |
| drying* (3 min at | | | | | |
| 80° C.) | | | | | |
| ^{d)}Film hazing | 0 | 0 | 0 | 0 | 0 |
| (visual) | | | | | |

*Assessment: 0 = good, 5 = poor

Descriptions of Test Methods

a) Solvent Resistance
To determine the solvent resistance, a cottonwool pad soaked with solvent was placed onto a coated substrate and covered with a watch glass. After the exposure time, the cottonwool pad and any solvent residues are removed and the surface of the coating material is rated by inspection.

b) Sodium Hydroxide Resistance
To determine the sodium hydroxide resistance, the substrates under investigation were immersed vertically halfway into a bath containing 5% strength aqueous sodium hydroxide solution, covered and heated at 70° C. for 8 h. Thereafter the plates were rinsed off with deionized water and rated by inspection.

c) Initial Physical Drying
For the investigation of the initial physical drying, the corresponding clearcoat materials were applied to 3 mm glass plates from Schlier & Hennes using a coating knife from Deka (No. 120), subjected to preliminary drying at 80° C. for 3 minutes and then investigated for the absence of tack (0=tack-free to 5=highly tacky).

d) Film Hazing
The coating films were inspected after baking for signs of haze (0=nothing found to 5=very hazy)

Requirements with Regard to the Individual Technical Properties:

| | |
|---|---|
| a) Adhesion: | max. 1 |
| b) Pendulum hardness | min. >140, better >150 |
| c) Solvent resistance | each individual value not more than 2 |
| d) NaOH resistance | max. 1 |
| e) Yellowing | <2.0, better <1.0 |
| f) Initial physical drying | max. 2 |
| g) Film hazing | max. 1 |

Evaluation of Results:

With the non-inventive self-crosslinking baking systems it is not possible using the prior-art crosslinker dispersions to achieve a sufficient profile of properties in respect of initial physical drying, low thermal yellowing and absence of haze from the films (Examples 9-12). Even the blend of two non-inventive crosslinker dispersions shown in Example 13 (Example 1: oxime-blocked, Example 3: lactam-blocked) in the preparation of a self-crosslinking dispersion did not result in acceptable coatings.

Only when the inventive crosslinker dispersions were used, reacted with a lactam and with a further blocking agent (Examples 14-18), is it possible to achieve an optimum profile of the critical properties. The other film properties as well, such as the hardness of the coating film, solvent resistance and sodium hydroxide resistance, correspond to the requirements imposed on a high-value coating system.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Process for preparing aqueous dispersions of mixedly blocked polyisocyanate prepolymers, comprising:
1) preparing a polyisocyanate prepolymer by reacting:
a) 100 equivalents of at least one polyisocyanate component,
b) 10 to 75 equivalents of one or more lactams, as blocking agent(s) for isocyanate groups,
c) 2 to 50 equivalents of blocking agents for isocyanate groups, other than b),
d) 0 to 15 equivalents of at least one nonionic hydrophilicizing agent containing isocyanate-reactive groups,
e) 0.5 to 13 equivalents of at least one (potentially) anionic hydrophilicizing agent containing isocyanate-reactive groups,
f) 0 to 30 equivalents of one or more amino-free compounds having a molecular weight of from 62 to 250 g/mol and which have either 2 to 4 OH groups or at least one OH group and at least one further isocyanate-reactive group, and
g) 0 to 30 equivalents of one or more (cyclo)aliphatic compounds having a molecular weight of from 32 to 300 g/mol and which have either 2 to 4 amino groups or at least one amino group and at least one further isocyanate-reactive group,
2) dissolving or dispersing the polyisocyanate prepolymer in water during or after reaction of components a) to g) with one another, and
3) at least partially deprotonating the potentially anionic groups of the hydrophilicizing agents used in e) with a base before, during or after step 2).

2. Process for preparing aqueous dispersions of mixedly blocked polyisocyanate prepolymers according to claim 1, wherein polyisocyanates based on hexamethylene diisocyanate, isophorone diisocyanate and/or 4,4′-diisocyanatodicyclohexylmethane are used in component a).

3. Process for preparing aqueous dispersions of mixedly blocked polyisocyanate prepolymers according to claim 1, wherein ε-caprolactam is used as a blocking agent in component b).

4. Process for preparing aqueous dispersions of mixedly blocked polyisocyanate prepolymers according to claim 1, wherein butanone oxime, acetone oxime, 3,5-dimethylpyrazole and/or mixtures thereof are used as blocking agent(s) in component c).

5. Process for preparing aqueous dispersions of mixedly blocked polyisocyanate prepolymers according to claim 1, wherein the equivalent ratio of the isocyanate component (a) to isocyanate-reactive groups of components b), c), d), f) and g) is 1:0.7 to 1:1.3.

6. Aqueous dispersions of mixedly blocked polyisocyanate prepolymers obtained by a process according to claim 1.

7. Mixedly blocked polyisocyanate prepolymers comprising
A) at least one structural unit of the formula (I) 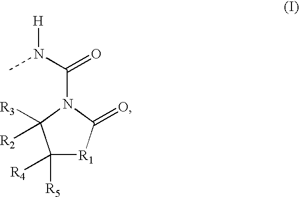
where
R₁ is a C₁ to C₃ alkylene radical and
R₂ to R₅ is a hydrogen atom,
B) (potentially) anionically hydrophilicizing groups and
C) optionally one or more oxyethylene units.

8. Aqueous coating compositions comprising mixedly blocked polyisocyanate prepolymers according to claim 7.

9. Aqueous coating compositions according to claim 8, wherein the coating compositions are baking systems.

10. Aqueous coating compositions according to claim 8, wherein the coating compositions further comprise water-soluble or -dispersible polyhydroxy compounds and optionally auxiliaries and adjuvants.

11. Coatings obtained from aqueous coating compositions according to claim 8.

12. Substrates coated with coatings according to claim 11.
